(19) United States
(12) Patent Application Publication
(10) Pub. No.: US 2009/0122962 A1
(43) Pub. Date: May 14, 2009

(54) Slotted x-ray filter

(76) Inventors: David Gould, Chelmsford, MA (US); Andrew Dean Foland, Cambridge, MA (US)

Correspondence Address: Iandiorio Teska & Coleman, 260 Bear Hill Road, Waltham, MA, 02451-1018, US

(21) Appl. No.: 12/291,781

(22) Filed: Nov. 13, 2008

Related U.S. Application Data
(60) Provisional application No. 61/003,005, filed on Nov. 14, 2007.

(51) Int. Cl. G21K 3/00

(52) U.S. Cl. 378/156

(57) ABSTRACT

An X-ray machine including a detector bank with high resolution detectors for imaging and low resolution detectors for CT reconstruction, and at least one X-ray source configured to direct a beam of X-rays impinging on both the high resolution and the low resolution detectors. A flux filter is located between the detector bank and the X-ray source and the flux filter includes attenuating material for attenuating a portion of the beam impinging on the low resolution detectors.

### RELATED APPLICATIONS

This application hereby claims the benefit of and priority to U.S. Provisional Application Ser. No. 61/003,005, filed on Nov. 14, 2007 under 35 U.S.C. §§119, 120, 363, 365, and 37 C.F.R. §1.55 and §1.78.

### FIELD OF THE INVENTION

This subject invention relates to X-ray machines, such as those used to inspect luggage and cargo.

### BACKGROUND OF THE INVENTION

The applicant hereof has engineered various X-ray machines used to inspect luggage and cargo.

In one example, a high resolution multi-view tomography three-dimensional X-ray imager may include multiple sources and detector banks. Each source generates an X-ray beam which impinges on a detector bank. Each detector bank may have multiple rows of detectors. Some rows could be used for imaging and the other rows could be used for CT reconstruction.

One technical issue with such an arrangement is that high flux is desirable for imaging but is of little benefit for detection and CT reconstruction.

### BRIEF SUMMARY OF THE INVENTION

It is therefore an object of this invention to provide an X-ray filter which allows a high flux to impinge on the high resolution detectors used for imaging but which attenuates X-rays impinging on the lower resolution detectors used for detection or CT reconstruction.

It is a further object of this invention to provide such a filter which reduces scattered radiation in the tunnel of the X-ray machine.

It is a further object of this invention to provide such a filter which allows the same high flux pulsing X-ray source to be used for imaging (where high flux is desirable) as well as for the skewed views used only for detection.

It is a further object of this invention to provide such a filter that allows greater tolerances on the dimensions of a collimator associated with the X-ray machine and also thinner X-ray shielding and curtains.

It is a further object of this invention to provide such a filter which reduces the cost of the X-ray machine.

It is a further object of this invention to provide such a filter which improves manufacturability.

It is a further object of this invention to provide such a filter which reduces the effect of scattered radiation.

The subject invention features an X-ray machine including a detector bank with high resolution detectors for imaging and low resolution detectors for CT reconstruction and at least one X-ray source configured to direct a beam of X-rays impinging on both the high resolution and the low resolution detectors. A flux filter is located between the detector bank and the X-ray source and the flux filter includes attenuating material for attenuating a portion of the beam impinging on the low resolution detectors.

In one example, the flux filter may include a slot in the attenuating material for the portion of the beam impinging on the high resolution detectors. The attenuating material may be a low atomic number material for minimizing the distortion of the output X-ray spectrum. The attenuating material may be beryllium, carbon, or aluminum. Or, the attenuating material may be a high atomic number material for emphasizing a particular portion of the output X-ray spectrum. The attenuating material may be steel. The X-ray source may include a window and the flux filter is typically over the window.

The subject invention also features a flux filter for an X-ray machine with an X-ray source generating a beam impinging on detector arrays. The preferred flux filter may include an attenuating portion for attenuating a component of the beam impinging on some detectors and a non-attenuating portion for a component of the beam impinging on other detectors. In one example, the attenuating portion may include an attenuating material and the non-attenuating portion includes a slot in the attenuating material.

One flux filter for an X-ray machine with an X-ray source generating a beam impinging on first and second detector arrays, in accordance with this invention, features a first attenuating portion for attenuating a component of the beam impinging on the first detector array and a second attenuating portion for a component of the beam impinging on the second detector array. In one example, the first attenuating portion may include a highly attenuating material and the second attenuating portion includes a low attenuating material.

The subject invention also includes a method of controlling the flux of an X-ray source in a system including imaging detectors and computed tomography reconstruction detectors. A filter is positioned between an X-ray source and the imaging and computed tomography detectors. The flux of X-rays from the source impinging on the tomography reconstruction detectors are attenuated without substantial attenuation of the flux of X-rays from the source impinging on the imaging detectors.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic three-dimensional view of an example of an X-ray machine that could be used in accordance with the subject invention;

FIG. 2 is a schematic three-dimensional view showing the X-ray sources and detector banks associated with the X-ray machine of FIG. 1;

FIG. 3 is a schematic cross-sectional view of an example of a flux filter in accordance with the subject invention;

FIG. 4 is a schematic three-dimensional exploded view showing an example of a flux filter in accordance with the subject invention to be positioned over the window of an X-ray source; and

FIG. 5 is a schematic three-dimensional view showing the different components of an X-ray beam after being filtered by the flux filter shown in FIG. 4.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

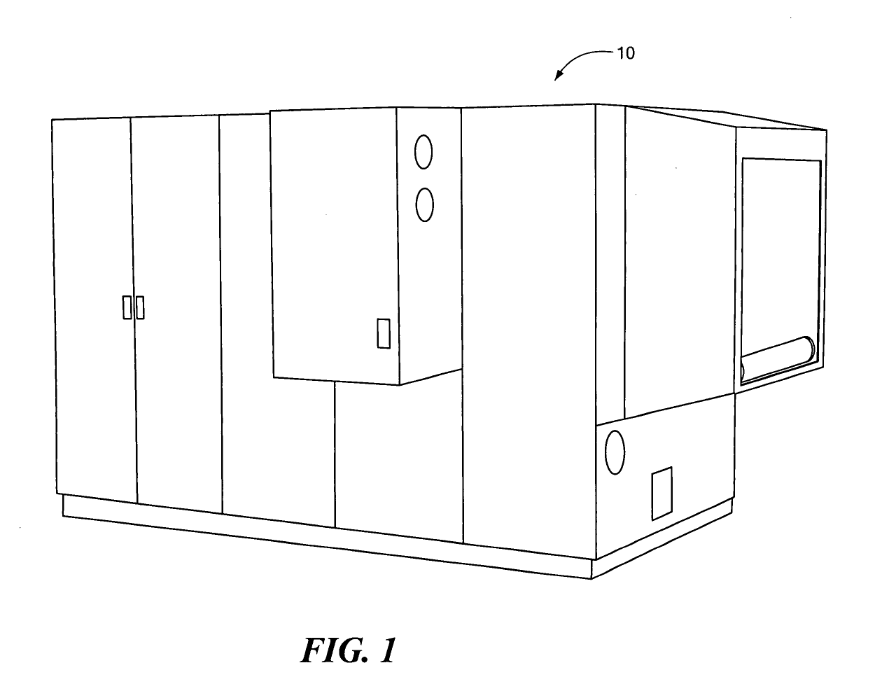

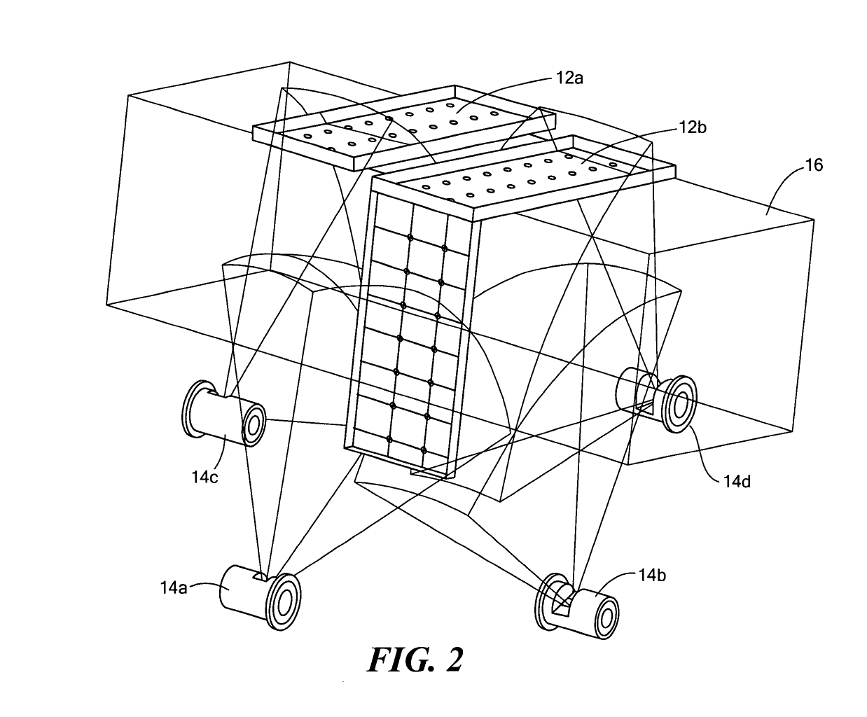

FIG. 1 shows an example of an X-ray machine 10 in accordance with the subject invention used for the inspection of baggage or cargo. As shown in FIG. 2, there are multiple L-shaped detector banks or arrays 12a and 12b and multiple X-ray sources 14a-14d directing X-ray beams across tunnel 16. For three-dimensional imaging, X-ray sources 14b and 14d provide different views as shown. Detector bank 12b includes multiple rows of detectors. The same is true with respect to the other detector banks. Typically, the center row includes high resolution detectors for imaging and the rows on either side of the center row include lower resolution detectors for CT reconstruction. The beam of X-rays from source 14b impinges on both the high resolution detectors and the low resolution detectors.

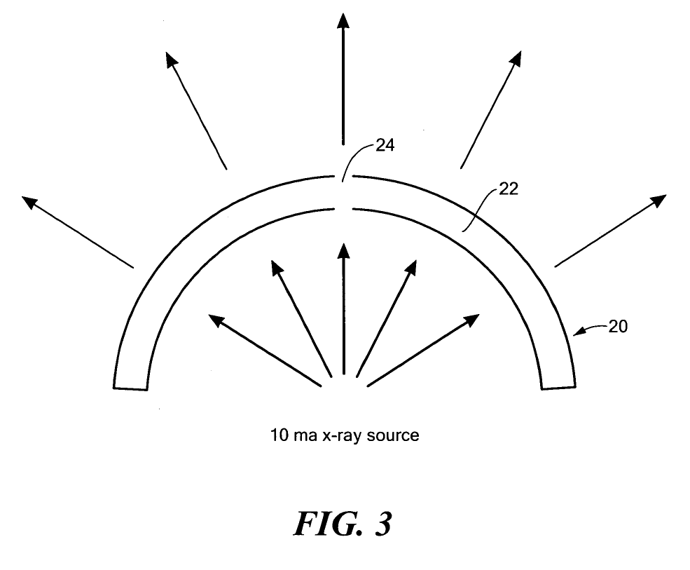

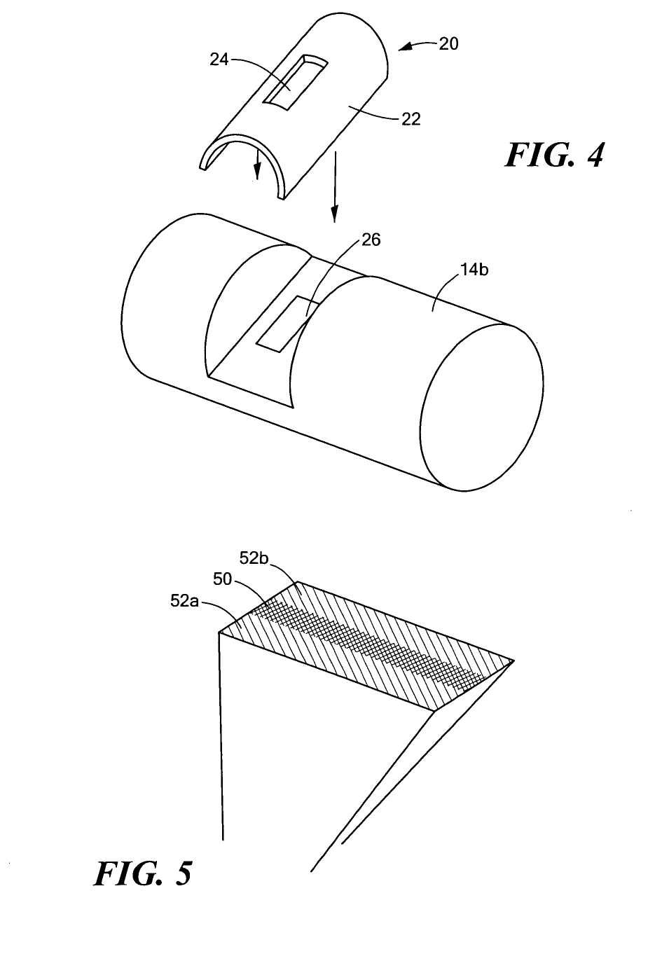

In accordance with the subject invention, flux filter 20, FIGS. 3-4 is disposed between the detector bank and the X-ray source and includes an attenuating material 22 (e.g., beryllium) for attenuating a portion of the beam impinging on the low resolution detectors. Slot 24 allows unattenuated X-ray energy to impinge upon the high resolution detectors of detector bank 12b, FIG. 2. As shown in FIG. 4, typical X-ray source 14b includes window 26 and filter 20 can be located over window 26. In a similar manner, such a filter can be placed on each X-ray sources 14a-14d, FIG. 2.

The resulting X-ray beams have an unfiltered component or region 50, FIG. 5 impinging on the high resolution detectors and filtered attenuated regions or components 52a and 52b impinging on the low resolution detectors. Such an X-ray beam allows the same high-flux pulsing X-ray source to be used for imaging (where high flux is desirable) as well as for the skewed views used only for detection where high-flux is not required. The lightly attenuating filter material is chosen to reduce the X-ray flux without changing the X-ray spectra in a useful range and typically includes a slot 24, FIG. 4 cut in the middle. The filter is positioned close to the X-ray tube window. The slot allows the beam to pass unimpeded for the imaging view or views but attenuates the beam for skewed views that are used for reconstruction. As shown in FIG. 3, the imaging views are not filtered due to slot 24, but the reconstruction views are filtered by material 22 to reduce the flux for an 8 MA X-ray source to the equivalent of a 2 MA X-ray source.

The result is the reduction of scattered radiation in the X-ray machine tunnel and the ability to use thinner X-ray shielding and curtains. The filter also allows greater tolerances on the dimensions for any collimator associated with the X-ray source. The tolerance on the collimator for reconstruction views are reduced since radiation is already dramatically reduced and it is therefore not as critical to tightly tolerance the slots of the collimator for the reconstruction views. Manufacturability is improved and system material cost is reduced. The effect of scattered radiation on the reconstruction imaging is also reduced. Various filters are known in the art. See U.S. Pat. Nos. 6,968,042; 7,397,904; and 7,340,282 incorporated herein by this reference. Known filters, however, are not well suited for the application discussed herein.

In another example, different thickness materials for the filter may be used and/or different materials may be used to modify the properties of different views to allow for multi-spectral analysis. Moreover, the shape of the filter shown in FIGS. 3 and 4 is not a limitation of the subject invention. Portion 22, FIG. 4, could be a low atomic number material for minimizing the distortion of the output X-ray spectrum. Portion 22 could be beryllium, carbon, or aluminum. Portion 22 could also, in contrast, be a high atomic number material for emphasizing a particular portion of the output X-ray spectrum. Portion 22 could be a highly attenuating material and slot 24 could be made of a low attenuating material or vice versa. Slot 24 does not substantially attenuate the flux of X-rays from the source which, by design, are intended to impinge on the imaging detectors.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An X-ray machine comprising:
a detector bank with high resolution detectors for imaging and low resolution detectors for CT reconstruction;
at least one X-ray source configured to direct a beam of X-rays impinging on both the high resolution and the low resolution detectors; and
a flux filter between the detector bank and the X-ray source, the flux filter including attenuating material for attenuating a portion of the beam impinging on the low resolution detectors.

2. The X-ray machine of claim 1 in which the flux filter includes a slot in the attenuating material for the portion of the beam impinging on the high resolution detectors.

3. The X-ray machine of claim 1 in which the attenuating material is a low atomic number material for minimizing the distortion of the output X-ray spectrum.

4. The X-ray machine of claim 1 in which the attenuating material is beryllium, carbon, or aluminum.

5. The X-ray machine of claim 1 in which the attenuating material is a high atomic number material for emphasizing a particular portion of the output X-ray spectrum.

6. The X-ray machine of claim 1 in which the attenuating material is steel.

7. The X-ray machine of claim 1 in which the X-ray source includes a window and the flux filter is over the window.

8. A flux filter for an X-ray machine with an X-ray source generating a beam impinging on at least first and second detector arrays, the flux filter comprising:
an attenuating portion for attenuating a component of the beam impinging on the first detector array; and
a non-attenuating portion for a component of the beam impinging on the second detector array.

9. The flux filter of claim 8 in which the attenuating portion includes an attenuating material and the non-attenuating portion includes a slot in the attenuating material.

10. A flux filter for an X-ray machine with an X-ray source generating a beam impinging on at least first and second detector arrays, the flux filter comprising:
a first attenuating portion for attenuating a component of the beam impinging on the first detector array; and
a second attenuating portion for a component of the beam impinging on the second detector array.

11. The flux filter of claim 10 in which the first attenuating portion includes a highly attenuating material and the second attenuating portion includes a low attenuating material.

12. A method of controlling the flux of an X-ray source in a system including imaging detectors and computed tomography reconstruction detectors, the method comprising positioning a filter between the X-ray source and the imaging detectors and the computed tomography detectors and attenuating the flux of X-rays from the source impinging on the tomography reconstruction detectors without substantial attenuation of the flux of X-rays from the source impinging on the imaging detectors.
